(19) United States
(12) Patent Application Publication
(10) Pub. No.: US 2006/0257616 A1
(43) Pub. Date: Nov. 16, 2006

(54) Renewable nonwoven carpet

(75) Inventors: James E. Hendrix, Pacolet, SC (US); H.W. Gosney, McAdenville, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Stowe-Pharr Mills, Inc. (d/b/a Pharr Yarns, Inc.)

(21) Appl. No.: 11/127,417

(22) Filed: May 12, 2005

(51) Int. Cl. B32B 33/00; D04H 11/00

(52) U.S. Cl. 428/85; 428/97; 428/95

(57) ABSTRACT

A carpet constructed from a biodegradable nonwoven face layer and a backing layer that is biodegradable and/or recyclable. The face layer comprises a needle-punched nonwoven web formed from a blend of different fiber types each of which is biodegradable, the blend comprising face fibers having a relatively high decomposition temperature and thermally activatable binder fibers having a thermal activation temperature lower than the decomposition temperature of the face fibers. The binder fibers bind to one another and to the face fibers. The face fibers can comprise one or more types of fibers that are biodegradable. Suitable fiber types include but are not limited to wool, hemp, cotton, polylactic acid, jute, flax, kanaf, sisal, rayon, and silk. The binder fibers in some embodiments of the invention comprise low-melt polylactic acid.

### BACKGROUND OF THE INVENTION

The present invention relates to carpet in general, and relates more particularly to a completely renewable nonwoven carpet.

Traditional carpet products are made from materials that are resistant to biological degradation. For instance, carpets are typically produced from tufted yarns of nylon, polyester, acrylic, or polypropylene. Commonly, the tufted yarns are anchored to a primary fabric backing such as woven polypropylene. A coating of styrene-butadiene rubber (SBR) filled with calcium carbonate is applied to the primary backing, followed by a second coating of styrene-butadiene rubber, and a secondary backing such as woven polypropylene fabric or polyvinyl chloride foam is bonded to the primary backing via the SBR coatings. In another common technique, carpet is made in the form of tiles for gluing to the floor, by using a dense polypropylene or polyvinyl chloride backing in place of the secondary backing, and subsequently die-cutting the carpet into squares. The types of carpet products described above are not biodegradable and thus do not constitute renewable products.

Some carpets have incorporated some biodegradable materials in their construction. For instance, wool is often used for face fiber in carpets, as is cotton, jute, and even cocoanut. However, other components such as the primary backing and latexes, which are necessary to give the carpet mechanical integrity, are not biodegradable. These non-biodegradable components have proved to be necessary in conventional carpet constructions in order to achieve the desired performance in use. As a consequence, billions of pounds of spent carpet products end up in landfills each year. Since they are not biodegradable, they will remain in the ground essentially forever.

There is a need for an aesthetically pleasing carpet that can attain performance levels comparable to those of conventional carpet products, while being constructed entirely of renewable materials or materials that can be recycled.

### BRIEF SUMMARY OF THE INVENTION

The present invention addresses the above needs and achieves other advantages, by providing a carpet constructed from a biodegradable nonwoven face layer and a backing layer that is biodegradable and/or recyclable. In accordance with an embodiment of the invention, the face layer comprises a needle-punched nonwoven web formed from a blend of different fiber types each of which is biodegradable, the blend comprising face fibers having a relatively high decomposition temperature and thermally activatable binder fibers having a thermal activation temperature lower than the decomposition temperature of the face fibers. The binder fibers bind to one another and to the face fibers.

The face fibers can comprise one or more types of fibers that are biodegradable. Suitable fiber types include but are not limited to wool, hemp, cotton, polylactic acid, jute, flax, kanaf, sisal, rayon, and silk. The binder fibers in some embodiments of the invention comprise low-melt polylactic acid (PLA), either as monofilament type fibers of PLA or as bicomponent fibers having a high-melt core of biodegradable polymer and a sheath of low-melt PLA. Advantageously, the binder fibers comprise 5% to 30% of the total blend by weight, and more preferably comprise about 10% to 20% by weight.

In some embodiments, the nonwoven face layer comprises two different types of biodegradable face fibers. For instance, the face fibers can comprise wool and hemp in various relative proportions. Alternatively, the face fibers can comprise flax and PLA, wool and PLA, kanaf and PLA, or other combinations of fibers in various proportions. Alternatively, the face fibers may comprise a single type of fiber, such as wool, hemp, flax, or the like.

The backing layer can comprise PLA in bulk form, which is applied to the lower surface of the nonwoven face layer. Alternatively, the backing can be a recyclable polymer such as recyclable polyvinyl chloride.

Various aesthetic effects can be achieved in accordance with the invention. In some embodiments, the nonwoven face layer is formed from two or more different types of face fibers that are visually distinct from one another. For example, the different fibers can be of different colors. Depending on how the fibers are blended and placed into the nonwoven web, various aesthetic effects can be attained. Thorough and intimate blending of the different fibers, for instance, will result in a substantially uniform color of the nonwoven web. Alternatively, a non-uniform color can be imparted by less-thorough blending, or streaks may be formed by feeding strips or strands of different colored fiber onto the nonwoven web before needle-punching.

### DETAILED DESCRIPTION OF THE INVENTION

The present inventions now will be described more fully hereinafter with reference to certain preferred embodiments thereof. However, these inventions may be embodied in many different forms and should not be construed as limited to the embodiments set forth herein; rather, these embodiments are provided so that this disclosure will satisfy applicable legal requirements. Like numbers refer to like elements throughout.

In accordance with the present invention, a renewable carpet is produced by blending thermally activatable, biodegradable binder fibers with one or more types of biodegradable face fibers and forming a nonwoven web. The web can be formed by a dry-laying process such as by carding and cross-lapping or by air-laying fibers on a continuous moving belt to form a web suitable for further processing. Once formed, the web is needle-punched to mechanically interlock and orient the fibers, and to densify the web. The web is then heated to a temperature sufficient to activate the binder fibers, but below the decomposition temperature(s) of the one or more types of face fibers. The binder fibers bind to one another and to the face fibers, producing a dimensionally stable web. In some embodiments, the nonwoven web is not compressed during the binder fiber activation process; alternatively, some degree of compression of the web can be used. The resulting nonwoven web is then further dimensionally stabilized by applying a backing of a polymer material that is biodegradable and/or recyclable. The backing can be applied by extrusion-coating or other suitable technique.

The binder fibers can comprise a biodegradable polyester such as polylactic acid (PLA), which is produced through fermentation of corn and parts of the corn plant. The production of fibers from PLA is known and hence is not described in detail herein. See, for example, U.S. Pat. No. 5,010,145 and U.S. Pat. No. 6,761,970, which are incorporated herein by reference.

The binder fibers can comprise bicomponent fibers having a core that has a relatively high melting point temperature, and a sheath of PLA having a relatively lower melting point temperature. The degree of polymerization and other variables can be controlled during the production of PLA in order to tailor the melting point, as known in the art.

Where the face fibers include PLA fibers and the binder fibers comprise PLA, the fibers are tailored so that the PLA face fibers have a higher melting point temperature than that of the binder fibers.

A wide variety of fiber blends can be used in accordance with the invention. The face fibers can be a single type, or two or more different types of face fibers can be used. Face fibers such as wool, hemp, cotton, polylactic acid, jute, flax, kanaf, sisal, rayon, and silk can be used, although the invention is not limited to only these types. Essentially, any biodegradable fiber that possesses the requisite aesthetic and mechanical properties desired for a particular application can be used.

As illustrated by the following examples, the incorporation of biodegradable, thermally activated binder fibers such as PLA fibers is important to the durability of the carpet in use. Without using the biodegradable binder fibers, it is possible to produce an aesthetically attractive carpet product that is comfortable to walk on, but foot traffic and the like will soon pull out the fibers and the carpet will wear out. In conventionally constructed tufted carpets, this problem is avoided by converting the fiber web into yams and embedding each yarn in the polymeric backing. However, with nonwoven construction there are no yams but rather individual fibers, and the backing alone is not sufficient to anchor the fibers in such a manner that they resist being pulled out. In accordance with the invention, the binder fibers are intimately commingled with the face fibers and become bonded to them when heated above the activation temperature of the binder polymer. The binder fibers allow the production of a carpet that can withstand the rigors of use.

### EXAMPLES

### Example 1

Wool fibers were blended together with different amounts of low-melt polyester (polyethylene terephthalate) binder fibers. The resulting fiber blend was carded, cross-lapped, and needle-punched to form a nonwoven web, and the web was heated without compression to 300° F. to activate the binder fibers. The nonwoven web was backed with a recyclable PVC backing, cut into 18×18-inch carpet tiles, and tested to assess performance. The results of the tests are listed in Table I:

TABLE I

| % Binder | | Radiant | | |
|---|---|---|---|---|
| Fiber | | Panel | Max. Smoke | Smoke |
| (by weight of | Performance | CRF² | Optical | Optical |
| total blend)* | Rating¹ | (W/cm²) | Density³ | Density⁴ |
| 5.0 | 5.25 | 0.77 | 354 | 229 |
| 9.5 | 5.0 | 0.84 | 426 | 239 |
| 15.0 | 6.00 | 0.80 | 286 | 181 |
| 20.0 | 6.25 | 0.86 | 190 | 126 |

¹Performance rating is based on a non-standard test for predicting performance of carpets in heavy use environments, on a scale of 1 to 10 (10 being most desirable). The test involves applying dirt to the surface of the carpet and rolling a weighted office chair base back and forth over the carpet surface such that the dirt is scrubbed into the surface by the chair base. The carpet is then cleaned and the appearance of the carpet is rated.
²ASTM E-648 Critical Radiant Flux
³ASTM E-662-recorded value is maximum specific smoke density attained with sample flaming
⁴ASTM E-662-recorded value is specific smoke density at 4 minutes from time sample began flaming

### Example 2

Equal weight proportions of polylactic acid fibers and flax fibers were blended together with various proportions of bicomponent binder fibers having a sheath of low-melt polyester and a core of higher-melt polyester (polyethylene terephthalate). The resulting fiber blend was carded, cross-lapped, and needle-punched to form a nonwoven web, and the web was heated without calendering or compression to 370° F. to activate the binder fibers. The nonwoven web was backed with a recyclable PVC backing, cut into 18×18-inch carpet tiles, and tested to simulate conditions in use. The results of the tests are listed in Table II:

TABLE II

| % Binder Fiber | |
|---|---|
| (by weight of total blend) | Rotary Chair Test⁵ |
| 0.0 | 0.0 (carpet disintegrated in testing) |
| 13.0 | 2.0 (after 25,000 cycles) |

⁵DIN 54324

### Example 3

Equal weight proportions of polylactic acid fibers and selected natural fibers (kanaf or wool) were blended together with bicomponent binder fibers (13% by weight of total blend) having a core of polyester and a sheath of low-melt polylactic acid. The resulting fiber blend was carded, cross-lapped, and needle-punched to form a nonwoven web, and the web was heated without compression to 370° F. to activate the binder fibers. The nonwoven web was backed with a recyclable PVC backing, cut into 18×18-inch carpet tiles, and tested to determine predicted performance in use. Test results are shown in Table III:

TABLE III

| Natural | | |
|---|---|---|
| Fiber Type | Rotary Chair Test⁶ | Tetrapod⁷ |
| Kanaf | — | 3.5 (after 100,000 cycles) |
| Wool | 3.5 (after 100,000 cycles) | 4.5 (after 100,000 cycles) |

⁶DIN 54324
⁷ASTM D-5251

Example 1 demonstrates the function of the binder fibers in improving the performance of needle-punched nonwoven carpet tiles in accordance with this invention. As the proportion of binder fiber was increased, performance ratings and smoke densities improved, with no adverse effect on flammability (i.e., radiant panel).

Example 2 again shows the value of binder fibers for enhancing the performance of the nonwoven carpet tiles. The sample without binder fibers quickly disintegrated during the rotary chair testing, while the sample containing 13% binder fibers had adequate performance for residential use.

Example 3 demonstrates that the use of binder fibers together with a blend of PLA fibers and an appropriate natural fiber can provide a renewable carpet tile product that would be predicted to perform well (based on rotary chair and tetrapod test data) under heavy commercial carpet end-use conditions.

As noted, the carpet samples for the above-described tests were made without compression of the nonwoven web during heating to activate the binder fibers. It thus appears that compression of the web during heating is not necessary. However, it is within the scope of the invention to alternatively employ some degree of compression during the activation of the binder fibers.

It is noted that the binder fibers used in the examples above are comprised all or in part of conventional polyester, i.e., polyethylene terephthalate, because acceptable biodegradable binder fibers have not been found to be commercially available. The amounts of such non-biodegradable polyester in the resulting carpet tiles would be less than 5% of the total weight of the carpet and would therefore have minimal environmental effects. It is anticipated that acceptable binder fibers that are completely biodegradable will be available in the near future, which will make possible the production of carpet that is truly renewable.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A renewable nonwoven carpet, comprising:
a nonwoven face layer, and a backing layer bonded to a lower surface of the face layer, the face layer being biodegradable, the backing layer comprising a polymer that has at least one of the properties of biodegradability and recyclability;
wherein the face layer comprises a needle-punched nonwoven web formed from a blend of different fiber types each of which is biodegradable, the blend comprising face fibers having a relatively high decomposition temperature and thermally activatable binder fibers having a thermal activation temperature lower than said decomposition temperature, the binder fibers binding to one another and to the face fibers.

2. The renewable nonwoven carpet of claim 1, wherein the face fibers comprise at least one type of natural fiber.

3. The renewable nonwoven carpet of claim 2, the natural fiber comprises wool.

4. The renewable nonwoven carpet of claim 1, wherein the face fibers comprise at least two different types of fibers.

5. The renewable nonwoven carpet of claim 4, wherein the face fibers comprise wool and hemp.

6. The renewable nonwoven carpet of claim 4, wherein the face fibers comprise polylactic acid fibers and natural fibers.

7. The renewable nonwoven carpet of claim 6, wherein the natural fibers comprise one or more of jute, flax, kanaf, hemp, cotton, wool, sisal, rayon, and silk.

8. The renewable nonwoven carpet of claim 1, wherein the binder fibers comprise polylactic acid.

9. The renewable nonwoven carpet of claim 8, wherein the binder fibers comprise bicomponent fibers having a core of biodegradable polymer and a sheath of polylactic acid, the sheath having a melting temperature lower than that of the core.

10. The renewable nonwoven carpet of claim 1, wherein the binder fibers comprise polyester.

11. The renewable nonwoven carpet of claim 1, wherein the binder fibers comprise 5% to 30% of the blend by weight.

12. The renewable nonwoven carpet of claim 1, wherein the backing layer comprises recyclable polyvinyl chloride.

13. The renewable nonwoven carpet of claim 1, wherein the backing layer comprises polylactic acid.

14. The renewable nonwoven carpet of claim 1, wherein the face layer comprises face fibers having a first color and face fibers having a second color distinct from the first color, the face fibers being placed into the nonwoven web in a manner providing the face layer with a color that is spatially non-uniform.

15. The renewable nonwoven carpet of claim 14, wherein the face fibers are free of added artificial dyestuffs or colorants.

16. A method for making a renewable nonwoven carpet, comprising the steps of:
forming a nonwoven web from a blend of different fiber types each of which is biodegradable, the blend comprising face fibers having a relatively high decomposition temperature and thermally activatable binder fibers having a thermal activation temperature lower than said decomposition temperature;
needle-punching the nonwoven web;
heating the needle-punched nonwoven web to activate the binder fibers such that the binder fibers bind to one another and to the face fibers; and
bonding the nonwoven web to a backing layer comprising a polymer that has at least one of the properties of biodegradability and recyclability.

17. The method of claim 16, wherein the heating step is carried out substantially without compression of the nonwoven web.

18. The method of claim 16, wherein the forming step comprises selecting first face fibers having a first color and second face fibers having a second color distinct from the first color, and placing the first and second face fibers into the nonwoven web in a manner providing the nonwoven web with a color that is spatially non-uniform.

19. The method of claim 18, wherein the first and second face fibers are selected to be free of added artificial dyestuffs or colorants.

20. The method of claim 16, wherein the forming step comprises adding strips or strands of fiber having a distinct color to the web prior to needle-punching to give the nonwoven web distinct streaks of color that are maintained in the final carpet.

21. The method of claim 16, wherein the backing layer employed in the bonding step comprises polylactic acid.

22. The method of claim 16, wherein the backing layer employed in the bonding step comprises recyclable polyvinyl chloride or polypropylene.

23. The method of claim 16, wherein the face fibers are selected to be one or more of wool, hemp, cotton, polylactic acid, jute, flax, kanaf, sisal, rayon, and silk.

24. The method of claim 16, further comprising the step of die-cutting the carpet into individual carpet tiles.
